(19) United States
(12) Patent Application Publication
(10) Pub. No.: US 2008/0034288 A1
(43) Pub. Date: Feb. 7, 2008

(54) Text-Driven Macros Integrated with a Help System of a Computer Program

(75) Inventors: Sergei R. Landar, Cambridge, MA (US); Tolga Oral, Winchester, MA (US)

Correspondence Address: CUENOT & FORSYTHE, L.L.C., 12230 FOREST HILL BLVD., STE. 120, WELLINGTON, FL, 33414, US

(73) Assignee: INTERNATIONAL BUSINESS MACHINES CORPORATION, Armonk, NY (US)

(21) Appl. No.: 11/461,794

(22) Filed: Aug. 2, 2006

(51) Int. Cl. G06F 9/00

(52) U.S. Cl. 715/700; 715/705; 715/764

(57) ABSTRACT

A method of automatically creating macros for a computer program can include identifying text instructions within a help documentation of a computer program and associating the text instructions with actions of the computer program. The method further can include creating a macro for the computer program using the actions and providing a user accessible mechanism within the computer program for invoking the macro.

### BACKGROUND

1. Field of the Invention

The present invention relates to the automatic creation of macros for use with computer program user help systems.

2. Description of the Related Art

A modern computer program is a complex system that is capable of performing a large number of functions. Those functions that are accessed more frequently by users typically can be invoked within the computer program through visual controls that require either a single user action or a minimal number of user actions. For example, functions of a computer program such as saving a file, opening a file, printing a file, etc., commonly are available as individual menu items or as selectable buttons within a toolbar.

This level of convenience is not provided for each and every function of a computer program. Modern computer programs simply are too complex. If a visual control were provided for each function performed by the computer program, the user interface, more than likely, would be exceedingly cluttered and difficult to use. Thus, the only way to invoke more esoteric functions, i.e. those that are used to a lesser degree by users, is through a combination of user commands or inputs. In illustration, to access a lesser-used function of a computer program, the user typically must navigate a menu hierarchy, select an option to reveal an “options” or “preferences” dialog, select an appropriate tab in the dialog, and then choose the desired options to activate the intended function.

Because accessing these lesser-used functions is not always an intuitive process, computer programs typically provide users with a help system. The help system can be implemented as one or more electronic documents including, but not limited to, markup language files, Portable Document Formatted files, compiled help files, etc. The help system provides instructional text that may be accessed through a search function, a table of contents, an index, or the like.

Within the help system, the user is provided with step-by-step, text instructions for invoking the function for which help was sought within the computer program. The help system instructions guide the user through the necessary steps with instructional text such as “Open the File menu; Select Properties; In the Properties dialog, click the Settings Button; Enter the file location; and Click OK”. The user can then implement each of the individual actions listed in the help system to perform the desired function.

Accessing the help system and manually implementing the actions described in the help documentation can be cumbersome. This is particularly true for more complex functions involving a larger number of individual actions. The user typically jumps back and forth between the computer program and the help system, continually referring to the text instructions to determine the next action to perform.

It would be beneficial to provide a technique for accessing computer program functions which addresses the limitations described above.

### SUMMARY OF THE INVENTION

The present invention relates to the automatic creation of macros which can be integrated into a help system of a computer program. One embodiment of the present invention can include a method of automatically creating macros for a computer program. The method can include identifying text instructions within help documentation of a computer program and associating the text instructions with actions of the computer program. The method further can include creating a macro for the computer program using the actions and providing a user accessible mechanism within the computer program for invoking the macro.

Another embodiment of the present invention can include a method of automatically creating macros for a computer program including identifying a plurality of text instructions within a help system of the computer program. The method also can include associating each of the plurality of text instructions with at least one action of the computer program, generating a macro that, when executed, performs the actions, and inserting a source anchor within the help system. The source anchor can be associated with a universal resource locator corresponding to the macro.

Yet another embodiment of the present invention can include a machine readable storage being programmed to cause a machine to perform the various steps and/or functions described herein.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a block diagram illustrating a system for creating macros in accordance with one embodiment of the present invention.

FIG. 2 is a flow chart illustrating a method of creating macros in accordance with another embodiment of the present invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

The embodiments disclosed herein relate to the automatic creation of macros for use with a help system of a computer program. More particularly, the help documentation of a computer program or application can be analyzed to identify text instructions that provide step-by-step guidance to a user as to how to perform a particular function within the computer program. The text instructions can be correlated with, or mapped to, the particular actions of the computer program to which the instructions refer. These actions can be used to create a macro which, when executed, performs the individual actions thereby implementing the function.

The macro also can be associated with a visual control which causes the macro to be executed. The visual control can be inserted into the computer program. For example, the visual control can be inserted into the help documentation of the computer program, thereby providing a more efficient and automated way for users to perform lesser-used functions of the computer program. Accordingly, rather than manually following the text instructions provided in the help system to perform a given function, users can simply select the visual control to activate or execute the macro.

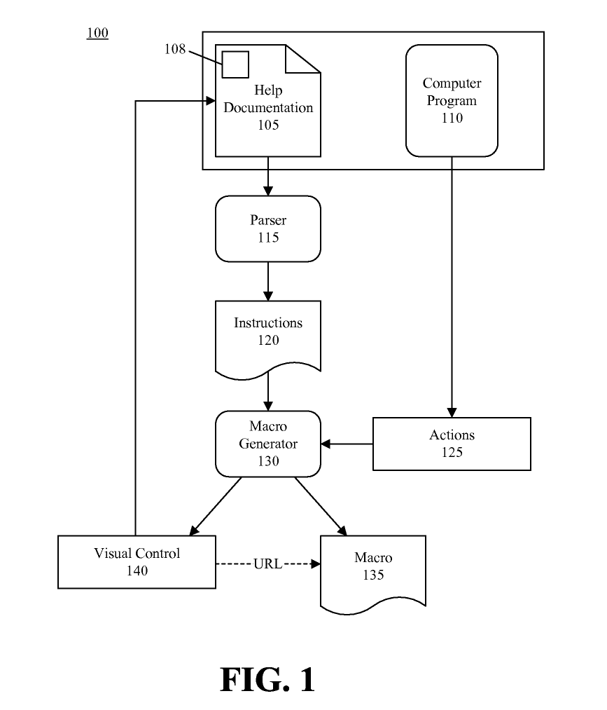

FIG. 1 is a block diagram illustrating a system 100 for creating macros in accordance with one embodiment of the present invention. In general, the term “macro” can refer to an object that specifies a list of commands, actions, or keystrokes (collectively called “actions”). The macro can be executed to automatically perform the various actions specified by the macro. In one embodiment, a macro can refer to a program, or portion of a program, which will execute a plurality of actions in series thereby saving the user from having to manually perform the actions one by one.

FIG. 1 depicts help documentation 105 for a computer program 110. The help documentation 105 can be part of a help system and can be implemented as a collection of one or more files, formatted in any of a variety of different file formats. For example, the help documentation 105 can be implemented as one or more text files, portable document formatted (PDF) files, a compiled help file as indicated by a “chm” file extension, or any combination thereof. The particular manner in which the help documentation 105 is implemented is not intended to limit the present invention. As such, any type of help documentation can be processed so long as the content, i.e. text instructions, can be processed or parsed as described herein.

The parser 115 can process the help documentation 105. More particularly, the parser 115 can utilize various text searching algorithms, rules, and/or the like, to determine information about the help documentation 105. In general, the parser 115 can identify text instructions 120 specified within the help documentation 105, the particular function to which each instruction 120 corresponds, as well as the order in which the instruction(s) 120 appear within the help documentation 105.

The parser 115 can be configured to locate portions of text that have been determined to be user instructions for performing the individual actions that must be taken to implement a given function within the computer program 110. The term “function”, as used herein, can refer to a set of one or more actions available within a computer program. Examples of functions can include, but are not limited to, translating a file from one format to another, processing a digital image to remove “red-eye”, increasing the contrast of a digital image, writing to optical media, or the like. The term “function” also can refer to the case in which a user must configure the computer program. The user may need to access various interfaces and select different options to properly configure the computer program to operate in a user-intended manner. For example, when copying files, a user may wish to specify that the computer program compress all files prior to writing. The task or process of instructing the computer program to utilize compression can be considered a function.

With this in mind, examples of actions that must be taken to implement a function can include, but are not limited to, opening a file, clicking “OK”, selecting check boxes or radio buttons in a dialog, etc. Each of these actions can be described as a text instruction within the help documentation 105. For example, opening a file may be indicated by the instructional text “File Open”. Other examples of instructions 120 can include “Open File menu”, “Select Properties menu item”, “In the Properties dialog, click the Settings button”, “Enter the file location in the text field”, and “Click OK”. Each individual text phrase, i.e. “Open File menu”, can be considered a single instruction 120 within the help documentation 105.

In addition to identifying the instructions 120 of the help documentation 105, each of the instructions 120 can be associated with a particular function. That is, each instruction 120 can be considered to be part of an ordered set of one or more instructions for performing a particular function as specified in the help documentation 105. As such, the parser 115 not only can identify instructions 120, but also associate each instruction 120 with a particular function. The parser 115 further can determine the order of the instruction 120 within the set of instructions identified for performing the function.

In one embodiment, the parser 115 can determine sets of instructions 120 by locating instructions that are close to one another within the help documentation 105. For example, instructions 120 that are located close to one another, i.e. within a predetermined number of words of one another, within a same list such as a bulleted or numbered list, can be considered to be part of the same ordered set of instructions for performing a specific or same function.

In another embodiment, the help documentation 105 can be processed to identify demarcations that separate one section of the help documentation 105 from another. Any instructions 120 located between such demarcations, i.e. within a same section, can be considered to be part of the same set of instructions for performing the same function. In illustration, a chapter or a subchapter of the help documentation 105 can be considered a section. If formed of a plurality of individual files, each file may serve as a section. If, for example, the help documentation 105 is implemented using a markup language, particular tags can be identified as demarcations for sections. Other attributes such as text formatting applied to the content of the help documentation 105 can serve as demarcations.

In one embodiment, the help documentation 105 can be written in such a way as to include various tags or identifiers, commonly referred to as annotations 108, signifying instructions, instruction sets, and corresponding functions. The help documentation 105 can be written in a manner that conforms to an established format. This format, with the annotations 108, can be processed or understood by the parser 115 in determining the information described above.

The information obtained from parsing the help documentation 105 can be stored or maintained using any of a variety of different techniques. In one embodiment, the parser 115 can generate an annotated version of the content of the help documentation 105 with each instruction 120 being tagged or otherwise annotated. The annotated content further can include or indicate section demarcations, instruction sets, and/or functions corresponding to the instruction sets. In another embodiment, each of the instructions 120 can be extracted and associated with an identifier that indicates the particular function in the help documentation 105 to which the instruction corresponds. The identifier, or another identifier, can indicate the order of the instruction 120 within the chain of instructions corresponding to the function. As instructions 120, relationships among instructions 120, and relationships between instructions 120 and functions can be represented in any of a variety of different ways, the particular manner in which such information is represented is not intended to be a limitation of the present invention.

The macro generator 130 can process the instructions 120 along with actions 125 of the computer program 110 to generate one or more macros 135 and corresponding visual controls 140. More particularly, the macro generator 130 can match or associate each of the instructions 120 with one or more actions 125. In one embodiment, each instruction 120 can be associated with a user interface operation in the native environment of the computer program 110. For example, this can be performed by obtaining the handle of the appropriate user interface window in a Windows® type of computing environment or a menu item reference in a markup language application.

In another embodiment, each instruction can be associated or matched with a particular service provider interface (SPI) that may be provided or made available by the computer program 110. SPIs can be indicated by developers through the use of annotation tags, for example, within the code of the computer program 110 or by providing a separate file specifying SPI data. In yet another embodiment, instructions located by the parser can be manually paired with actions 125. In any case, individual text instructions such as “open file menu” can be associated with the values, key sequences, parameters, and/or other code that must be provided to the computer program 110 to perform the “open file menu” action.

In another embodiment, the macro generator 130 can identify any items of information that are to be provided by the user for performing any actions 125 of a given function. The need for user-supplied input for actions 125 can be determined, for example, by identifying symbols within the help documentation 105 that indicate user input is to be supplied or by identifying annotations that can be provided within the code of computer program 110 which indicate that user input is needed. When the macro 135 being generated is later run, a user interface can be presented to collect these items of information from the user. This allows the user to provide any needed information for a macro 135 through a unified interface.

In any case, having paired instructions 120 with corresponding actions 125 of the computer program 110, the macro generator 130 can create a macro 135 for each of the functions, or ordered sets of instructions 120. Each macro 135 can implement selected ones of the actions 125 according to the order in which the instructions 120 corresponding to the actions 125 are located within the help documentation 105.

In addition to creating the macros 135, a visual control 140 can be created for each of the macros 135. In one embodiment, as shown, the visual controls 140 can be inserted into the help documentation 105. For example, before, near, or following each identified set of ordered instructions, i.e. for each function, a visual control 140 can be inserted within the help documentation 105. Each visual control 140 can serve as a source anchor for executing the macro 135 associated with that visual control 140. As such, each visual control 140 can be associated with a universal resource locator (URL) corresponding to the macro 135 that is generated from the instruction set near which the visual control 140 is inserted. For example, at the end of each section of help documentation 105, a visual control or anchor can be inserted with text stating “Do it!” or “Perform Function”.

User selection of the visual control 140 can execute the macro 135 thereby causing the computer program to perform the actions 125 associated with the set of instructions 120 located proximate to the visual control 140. In another embodiment, users can drag the visual control(s) from the help documentation 105 onto a tool bar user interface element within the computer program 110. Any of a variety of known shortcut creation techniques can be used including, but not limited to, assigning short cut keys. This relieves the user from having to repeatedly consult the help documentation 105 for functions that are more commonly performed by that user.

The system 100 illustrated in FIG. 1 has been presented for purposes of illustration only. The system 100 represents one embodiment of the present invention. It should be appreciated that the various components referenced in FIG. 1 can be combined into a single, more complex computer program or broken down into additional, less complex computer programs.

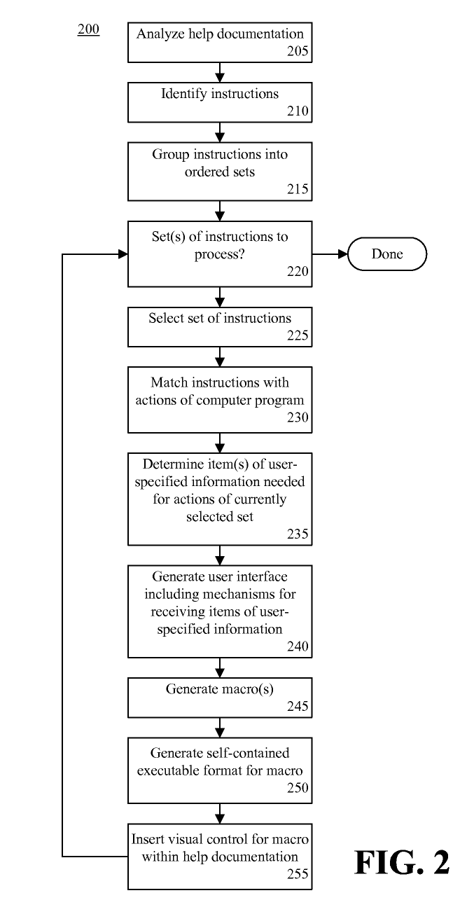

FIG. 2 is a flow chart illustrating a method 200 of creating a macro in accordance with another embodiment of the present invention. The method 200 can begin in step 205 where help documentation for a computer program can be analyzed. In step 210, based upon that analysis, text instructions within the help documentation can be identified. The instructions can be identified using any of a variety of different text processing techniques.

In step 215, the instructions can be grouped into sets that correspond to the various functions of the computer program as determined from the analysis of the help documentation. As noted, the sets of instructions can be determined according to proximity of the instructions with respect to one another within the help documentation, the location of the instructions with respect to various section demarcations of the help documentation, or other criteria. The order in which the instructions appear within the help documentation also can be determined or noted. Thus, each function of the computer program can be associated with an ordered set of one or more instructions.

In step 220, a determination can be made as to whether any further sets of instructions remain to be processed. If so, the method can proceed to step 225. If not, the method can end. In step 225, a set of instructions can be selected for processing. In step 230, each of the instructions of the selected set of instructions can be associated with, or mapped to, one or more actions of the computer program. As noted, the instructions can be associated with user interface operations or SPIs provided by the computer program itself.

In any case, in step 235, any items of information that must be specified by the user to perform an action mapped to an instruction of the currently selected set of instructions can be identified. For example, it may be the case that particular actions, such as opening a file, require a user to indicate the specific file to be opened. In another example, if the computer program is a digital image processing application, the user may be required to specify a type of file conversion algorithm or level of quality to be used in processing the file. These are but a few examples of the many different types of information that may be required from a user to perform the actions mapped to the instructions of the currently selected set of instructions.

In step 240, a user interface can be generated which includes a data entry mechanism for receiving each item of user-specified information identified in step 235. The user interface can be associated with, or become part of, the macro that will be generated. Referring to the previous example, the user interface can include a text box for receiving a path and filename as well as a browse button allowing the user to navigate to, and indicate, the desired file. The user interface can include radio buttons or check boxes for selecting other options such as the type of file conversion to be performed.

It should be appreciated that the particular user interface controls and data entry mechanisms included in the user interface can depend upon the types of items of information determined in step 235. In any case, the user interface can be presented to the user when the macro that will be generated for the currently selected set of instructions is executed. By presenting a single user interface for receiving all of the information needed to execute the macro, the process of performing the function is simplified. It should be appreciated, however, that if preferred, a plurality of user interfaces can be created, similar to a wizard, for querying the user and collecting the items of information needed to execute the macro.

In step 245, a macro can be created automatically. The macro can be comprised of code which invokes, or performs, each constituent action in the same order in which the instructions of the set of instructions are located, or ordered, within the help documentation. The macro code further can cause any user interfaces associated with that macro for receiving items of user-specified information to be presented. Items of information supplied to the user interface can be made available to the macro.

In step 250, the macro can be converted into a self-contained, executable format. In step 255, a visual control, which, when activated, causes the macro to be executed, can be included within the help documentation of the computer program. In one embodiment, the visual control can be positioned within the help documentation at a location that is proximate to the set of instructions. For example, the visual control, such as button or link indicating “Do it!” or “Perform this task”, can be located to the right or left of the set of instructions, just prior to the set of instructions, immediately following the set of instructions, or at some point within the same section of the help documentation as the set of instructions. In another embodiment, the visual control can be made available within a table of contents, for example next to the entry in the table of contents corresponding to the function performed by the macro or proximate to a heading in the text that indicates the function.

Regardless of where the visual control is located, the visual control can serve as a source anchor. The visual control can be associated with a URL corresponding to the location where the macro is, or will be, stored. Accordingly, when the visual control is selected, or otherwise activated, the macro can be executed. After step 255, the method 200 can loop back to step 220 and continue processing as may be required.

The method 200 has been presented for purposes of illustration and represents one embodiment of the present invention. As such, one or more of the steps discussed with reference to FIG. 2 can be performed in a different order than discussed without departing from the spirit of the invention.

The inventive arrangements disclosed herein provide a technique for automatically creating macros from a help system of a computer program. The help system can be augmented with the automatically generated macros thereby providing users with the ability to execute the macros in lieu of manually following the text instructions specified in the help system. As noted, the embodiments disclosed herein can be provided or performed as part of an initial build of a help system. In that case, for example, additional text indicators or clues can be included in the help documentation to aid the parser in identifying instructions. The embodiments disclosed herein also can be provided as part of a product enhancement or as a standalone solution which can be integrated with a third party application.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein. The present invention also can be embedded in a computer program product, which comprises all the features enabling the implementation of the methods described herein, and which when loaded in a computer system is able to carry out these methods.

The terms “computer program”, “software”, “application”, variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, a computer program can include, but is not limited to, a subroutine, a function, a procedure, an object method, an object implementation, an executable application, an applet, a servlet, a source code, an object code, a shared library/dynamic load library and/or other sequence of instructions designed for execution on a computer system.

The terms “a” and “an”, as used herein, are defined as one or more than one. The term “plurality”, as used herein, is defined as two or more than two. The term “another”, as used herein, is defined as at least a second or more. The terms “including” and/or “having”, as used herein, are defined as comprising, i.e. open language. The term “coupled”, as used herein, is defined as connected, although not necessarily directly, and not necessarily mechanically, i.e. communicatively linked through a communication channel or pathway or another component or system.

This invention can be embodied in other forms without departing from the spirit or essential attributes thereof. Accordingly, reference should be made to the following claims, rather than to the foregoing specification, as indicating the scope of the invention.

What is claimed is:

1. A method of automatically creating macros for a computer program comprising:
identifying text instructions within help documentation of a computer program;
associating the text instructions with actions of the computer program;
creating a macro for the computer program using the actions; and
providing a user accessible mechanism within the computer program for invoking the macro.

2. The method of claim 1, wherein the user accessible mechanism is disposed within a help system of the computer program, the method further comprising, responsive to a user command, making a visual control for executing the macro available within a tool bar of the computer program.

3. The method of claim 1, wherein providing a user accessible mechanism further comprises inserting a control within the help documentation, wherein activation of the control executes the macro.

4. The method of claim 3, wherein the control is a source anchor, the method further comprising associating a universal resource locator corresponding to the macro with the source anchor.

5. The method of claim 1, wherein actions of the computer program are accessible through service provider interfaces, wherein associating the text instructions with actions of the computer program further comprises associating the text instructions with the service provider interfaces.

6. The method of claim 1, wherein identifying text instructions further comprises determining a set of text instructions having a defined order for implementing a function of the computer program.

7. The method of claim 6, wherein creating a macro further comprises selecting only actions corresponding to the set of text instructions and ordering the actions of the macro according to the defined order of the set of text instructions.

8. The method of claim 1, further comprising identifying at least one item of user-specified information required as input to an action.

9. The method of claim 8, further comprising creating a user interface configured to receive the at least one item of user-specified information, wherein the user interface is presented upon execution of the macro.

10. A method of automatically creating macros for a computer program comprising:
identifying a plurality of text instructions within a help system of the computer program;
associating each of the plurality of text instructions with at least one action of the computer program;
generating a macro that, when executed, performs each of the actions; and
inserting a source anchor within the help system and associating the source anchor with a universal resource locator corresponding to the macro.

11. The method of claim 10, wherein creating a macro further comprises generating code that performs the actions in the order in which the plurality of text instructions is located within the help system.

12. The method of claim 10, further comprising:
identifying at least one user-specified item of information needed by an action; and
creating a user interface configured to receive the at least one user-specified item of information, wherein the user interface is presented responsive to execution of the macro.

13. A machine readable storage, having stored thereon a computer program having a plurality of code sections for automatically creating macros, the machine readable storage comprising:
code for identifying text instructions within a help documentation of a computer program;
code for associating the text instructions with actions of the computer program;
code for creating a macro for the computer program using the actions; and
code for providing a user accessible mechanism within the computer program for invoking the macro.

14. The machine readable storage of claim 13, wherein the code for providing a user accessible mechanism disposes the user accessible mechanism within a help system of the computer program, the machine readable storage further comprising code for, responsive to a user command, making a visual control for executing the macro available within a tool bar of the computer program.

15. The machine readable storage of claim 13, wherein the code for providing a user accessible mechanism further comprises:
code for inserting a source anchor within the help documentation; and
code for associating a universal resource locator corresponding to the macro with the source anchor.

16. The machine readable storage of claim 13, wherein actions of the computer program are accessible through service provider interfaces, wherein the code for associating the text instructions with actions of the computer program further comprises code for associating the text instructions with the service provider interfaces.

17. The machine readable storage of claim 13, wherein the code for identifying text instructions further comprises code for determining a set of text instructions having a defined order for implementing a function of the computer program.

18. The machine readable storage of claim 17, wherein the code for creating a macro further comprises code for selecting only actions corresponding to the set of text instructions and code for ordering the actions of the macro according to the defined order of the set of text instructions.

19. The machine readable storage of claim 13, further comprising code for identifying at least one item of user-specified information required as input to an action.

20. The machine readable storage of claim 19, further comprising code for creating a user interface configured to receive the at least one item of user-specified information, wherein the user interface is presented upon execution of the macro.
